(19) United States
(12) Patent Application Publication
(10) Pub. No.: US 2018/0041568 A1
(43) Pub. Date: Feb. 8, 2018

(54) LOAD BALANCING BY MOVING SESSIONS

(71) Applicant: SAP SE, Walldorf (DE)

(72) Inventor: Peter Eberlein, Malsch (DE)

(21) Appl. No.: 15/230,824

(22) Filed: Aug. 8, 2016

(51) Int. Cl. H04L 29/08

(52) U.S. Cl. CPC H04L 67/1002; H04L 67/142

(57) ABSTRACT

Methods, systems, and computer program products for processor node load balancing are described. A request for processing is received from a client hardware device, the request having a session identifier. A movable status of a session corresponding to the request is determined using one or more hardware processors, the session executing on a first hardware processor node of a plurality of hardware processor nodes. A load status of the first hardware processor node corresponding to the session is determined using the one or more hardware processors. The request is forwarded to a selected hardware processor node selected from the plurality of hardware processor nodes based on the movable status and the load status.

### FIELD

The present disclosure relates generally to managing processor nodes. In an example embodiment, the disclosure relates to load balancing processor nodes by moving processing sessions.

### BACKGROUND

Applications deployed to the cloud should generally be fully scalable, such as by simply starting additional processor nodes that can share some load when the resources of already running nodes are exceeded. For this to occur, the infrastructure as a service (IaaS) layer, for example, provides the computing power in the form of virtual machines with processors and memory and the platform as a service (PaaS) layer, for example, manages the dynamic start up (or shut down) of application instances on those virtual machines and performs load balancing of requests between all available nodes. Ideally, each request can be dispatched freely to any available node, following any of the standard algorithms, such as round-robin, thereby achieving even load distribution in the platform.

### BRIEF DESCRIPTION OF DRAWINGS

The present disclosure is illustrated by way of example and not limitation in the figures of the accompanying drawings, in which like references indicate similar elements and in which:

FIG. 1 is a block diagram of an example processing system for processing application requests, in accordance with an example embodiment;

FIG. 2A is an example sequence diagram for request dispatching, according to an example embodiment;

FIG. 2B is an example load vs. response time diagram, according to an example embodiment;

FIG. 3 is a block diagram of an example apparatus for implementing a load balancer, in accordance with an example embodiment;

FIG. 4A is a flowchart for an example method for processing an application request, according to an example embodiment;

FIG. 4B is a flowchart for an example method for processing an application response, according to an example embodiment;

FIG. 5 is a block diagram illustrating a mobile device, according to an example embodiment; and

FIG. 6 is a block diagram of a computer processing system within which a set of instructions may be executed for causing a computer to perform any one or more of the methodologies discussed herein.

### DETAILED DESCRIPTION

The description that follows includes illustrative systems, methods, techniques, instruction sequences, and computing program products that embody example embodiments of the present invention. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures and techniques have not been shown in detail.

Generally, methods, systems, apparatus, and computer program products for managing processor nodes are described. Requests for processing may be distributed to the processor nodes using a load balancing technique that allows sessions to be moved between processor nodes. Each session may submit multiple requests for the same application. Ideally, each request is dispatched freely to any available node, following any of the standard algorithms, such as round-robin, thereby achieving even load distribution in the platform. This, however, may entail that applications work in a completely stateless manner, as in this instance consecutive requests are to be dispatched to different nodes. While applications that are stateless are repeatedly requested for cloud applications, such applications cannot be achieved easily, especially without suffering other performance compromises. As most scenarios are too complex for being processed in a single request, session state typically needs to be established somewhere. If the application needs to be stateless, however, this session state has to be temporarily persisted outside of the application until the process is completed. This may be, for example, in the database as a draft document or in a centralized in-memory key-value store. Both options come with a cost for communicating with this external session store. In addition, it also increases the complexity of the overall landscape as this centralized session store should be introduced as a highly-available component.

Furthermore, application performance often benefits from the caching of data that is read when a session is started. This may comprise user data, authorization information, process context, master data, configuration information, and the like that need to be fetched, for example, from a database with a remote communication; the remote communication may consume a substantial amount of time. Also, as a process continues, additional data may have to be fetched, accumulating to the session context. For this to occur, additional database requests have to be issued that can be optimized if the database connection is pooled, which is only reasonable if consecutive requests are processed by the same node.

As a consequence, most applications are not implemented in a stateless way, but intentionally exploit the execution of consecutive requests in one and the same node, compromising on how freely requests can be dispatched. This limits the options of load balancers in achieving evenly distributed loads as most of the requests they receive for dispatching are already assigned to a certain node (known as being “sticky”). Only the initial requests originating from freshly logged on users can actually be assigned freely to any available node as determined by the load balancer. This can be particularly problematic since, in an overload situation, sticky sessions cannot be offloaded to idle nodes that have been started for exactly this reason. Only over time will new nodes get utilized, while overloaded nodes are recovered when sessions are released or closed. This already unfavorably delayed re-balancing can be further impaired by a generic load balancing algorithm, like round-robin, that does not dispatch new requests to the node with the lowest load, but just to the one that has not received any new request for the longest time, which incidentally may be a node that is under higher than average load.

For many scenarios, however, it is not an option for applications to become completely stateless. Therefore, in one example embodiment, a goal is to allow applications to maintain state for some period of time to efficiently complete multi-step processes, but enable the load balancer to reassign requests to other nodes at the favorable times in between these processes.

### Moving Sessions

In one example embodiment, an application communicates with the load balancer when all data from the session context has been persisted (e.g., there is “no data in flight”). The load balancer tracks information that indicates whether a session is movable (such as whether all session data has been persisted) and is therefore able to reassign the next request in case the node where the session was previously located is under significantly higher load than an alternative node that is available. In this case, the reassignment does not require the movement of data or state information to the new application node. While cached data may exist in volatile memory, it can easily be recreated in another session context on a different node; similarly, database connections may be recreated in another session context on a different node.

In addition, further requests may be dispatched to the same node as before in order to benefit from filled caches and connection pools. Therefore, the existing session is preliminarily maintained and not closed right away. The load balancer only closes the session on the previous node when a session is moved; the closure of the session is to guarantee that, at any point in time, a session context is active only on exactly one node. (Session contexts may exist simultaneously on different nodes, for example, as one node closes a session and another node starts a corresponding session.) When the request reaches the new node for the first time, a new session is created implicitly, and the original session identifier from the previous node is replaced.

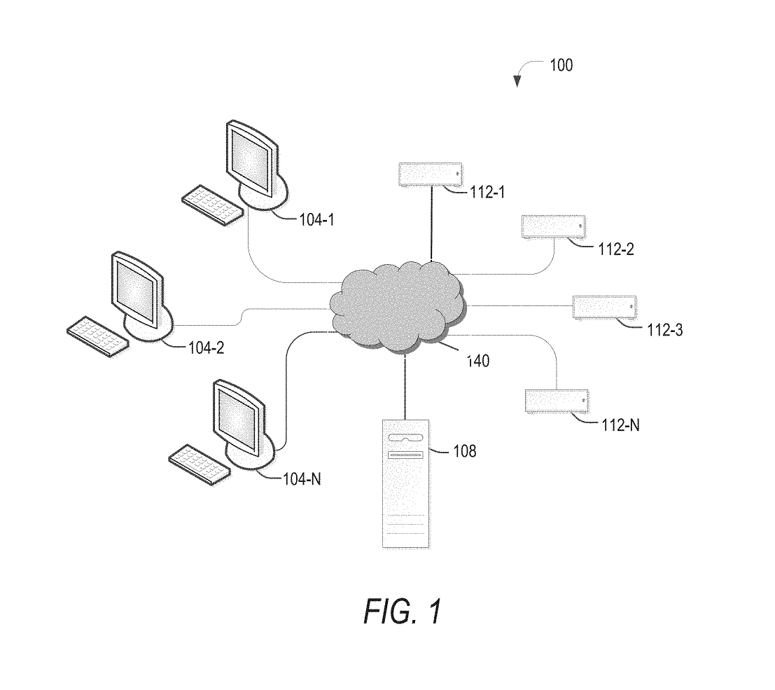

FIG. 1 is a block diagram of an example processing system 100 for processing application requests, in accordance with an example embodiment. In one example embodiment, the system 100 comprises client devices 104-1, . . . 104-N (collectively known as client devices 104 hereinafter), a load balancer 108, application nodes 112-1, . . . 112-N (collectively known as application nodes 112 hereinafter), and a network 140.

Each client device 104 may be a personal computer (PC), a tablet computer, a mobile phone, a telephone, a personal digital assistant (PDA), a wearable computing device (e.g., a smartwatch), or any other appropriate computer device. Client device 104 may include a user interface module. In one example embodiment, the user interface module may include a web browser program and/or an application, such as a mobile application, an electronic mail application, and the like. Although a detailed description is only illustrated for the client device 104, it is noted that other user devices may have corresponding elements with the same functionality.

The network 140 may be an ad hoc network, a switch, a router, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, another type of network, a network of interconnected networks, a combination of two or more such networks, and the like.

The load balancer 108 receives a request from a client device 104 and forwards the request to an application node 112, and forwards responses from the application node 112 to the client device 104. The load balancer 108 also maintains session information in a session table. The maintained information may include, for each node, the open session identifiers, a count of active requests for each session, a time of the last request, and an indication of whether the session is movable.

The application nodes 112 process requests from client devices 104 and return responses for the processed requests. In the example embodiment of FIG. 1, the application nodes 112 receive requests from the client devices 104 via the load balancer 108 and return the corresponding responses to the client devices 104 via the load balancer 108.

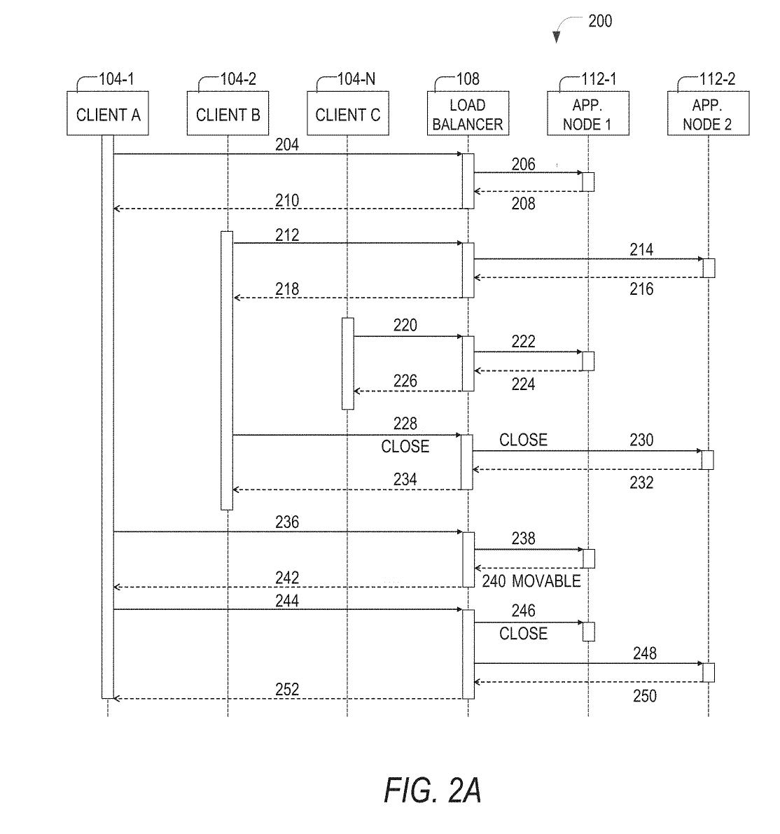

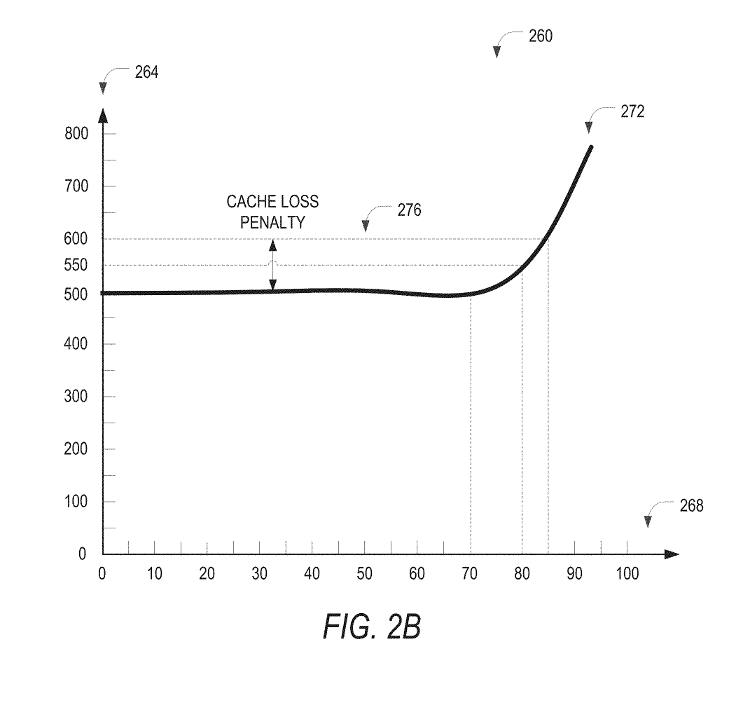

FIG. 2A is an example sequence diagram 200 for request dispatching, according to an example embodiment. As illustrated in FIG. 2A, the client device 104-1 (client A) issues a request 204 to the load balancer 108 and the load balancer 108 forwards a request 206 to the application node 112-1. Once the request 206 is processed, the application node 112-1 returns a response 208 to the load balancer 108, including an indication of whether the corresponding application is at a point where it can be moved. The indication may be included in a header field of the response. In the case of an application node 112 that is not configured to provide a moveable indicator, the header field will, by default, indicate that the application is not moveable. The load balancer 108 returns a response 210 to the client device 104-1.

Similarly, the client device 104-2 (client B) issues a request 212 to the load balancer 108 and the load balancer 108 forwards a request 214 to the application node 112-2. Once the request 214 is processed, the application node 112-2 returns a response 216 to the load balancer 108 and the load balancer 108 returns a response 218 to the client device 104-2. The client device 104-N (client C) issues a request 220 to the application node 112-1 via the load balancer 108 (see, request 222, response 224, and response 226). In the example of request 228 from the client device 104-2, the request 228 includes a close command which is forwarded from the load balancer 108 to the application node 112-2 via request 230. The application node 112-2 generates a response 232 and closes the corresponding session. The load balancer 108 forwards response 234 to the client device 104-2.

Also, as illustrated in FIG. 2A, client device 104-1 issues a second request 236 to the load balancer 108 and the load balancer 108 forwards a request 238 to the application node 112-1. Once the request 238 is processed, the application node 112-1 returns a response 240 to the load balancer 108, including an indication of whether the application is at a point where it can be moved. In this case, the application node 112-1 returns the result to the load balancer 108, including an indication that the application is at a point where it can be moved.

In one example embodiment, the application is not moved until another request to the application is received by the load balancer 108, as depicted in FIG. 2A. Thus, when the load balancer 108 receives the request 244 from client device 104-1, a close request 246 is issued for the corresponding session to the application node 112-1 and a request 248 is forwarded to the application node 112-2 for processing. A new session identifier is assigned and acknowledged in the ensuing response 250 from the application node 112-2 to the load balancer 108 and from the load balancer 108 to the client device 104-1 via a response 252.

### Determining Load

In one example embodiment, the load balancer 108 tracks the identity of the application nodes 112 where sessions are located in order to appropriately dispatch requests. With the protocol described above, the load balancer 108 also becomes aware of which sessions can be closed and moved to other nodes (transparently from the perspective of the user). By tracking additional data about the session status of each individual session, the load balancer 108 also gets a comprehensive overview about the current load distribution as a basis for dispatching new or reassigned sessions to the application nodes 112.

Table 1 below is an example session table of the load balancer 108.

| | | Active | | |
|---|---|---|---|---|
| Node | Session ID | Requests | Last Request | Movable |
| 1 | 12 | 2 | 17:45:12 | No |
| 1 | 29 | 0 | 17:45:15 | Yes |
| 1 | 42 | 0 | 17:45:20 | No |
| 1 | 51 | 0 | 17:45:33 | Yes |
| 2 | 15 | 0 | 17:11:45 | Yes |
| 2 | 19 | 1 | 17:44:08 | No |
| 2 | 23 | 0 | 17:45:22 | No |

The mapping of node to session identifier is used for dispatching a request to the application node 112 where the session context for the session corresponding to the request is located. The active requests field is incremented when a request is dispatched to an application node 112 and it is decremented when a response is received from an application node 112, thus maintaining a count of requests actively being handled by the corresponding application node 112 for the corresponding session. By summarizing all active requests of an application node 112, the load balancer 108 can derive the current load on that application node 112, which is correlated to the number of parallel requests being executed.

The last request field indicates the time of the last request (such as the time of the issuance of the last request) for the corresponding session; it serves as a second level indicator about possible future load when combined with the movable field. In essence, sessions that are not movable will create load in the future (that cannot be offloaded) for the assigned application node 112. The more recently that the last request took place, in general, the higher the probability that another request will be received soon, creating new load. Typically, only sessions that have not been in use for a long time (for example, on the order of an hour or more) might be or have been abandoned, and will be closed due to a timeout condition at some point in time, thus no longer creating additional load.

The movable field is updated with each response from the application: if the movable flag is set in the response header and there is no concurrent active request running, the movable field is set to yes; otherwise, the movable field is set to no. This information is used to decide if a load evaluation should be performed when the next request for this session is received; if the session cannot be moved anyway, such an evaluation would be ineffective.

In summary, when determining to which application node 112 a new or movable request is dispatched, the current load (given by the number of active requests for the current session as indicated in the session table), the future load that cannot be offloaded (given by the number of non-active, non-movable sessions, possibly adjusted by a probability factor based on how long ago the last request was received), or both is considered. The probability factor may be, for example:

1.0 for a last request occurring during the last minute;

0.9 for a last request occurring between 1 and 5 minutes ago;

0.5 for a last request occurring between 5 and 30 minutes ago;

0.2 for a last request occurring between 30 and 60 minutes ago; and

0.1 for a last request occurring greater than 60 minutes ago.

Future load that is movable does not affect this decision, as the corresponding session can still be moved to another application node 112 when an actual request for a movable session is received.

Also, note that there should be a significant difference between the load on the current application node 112 and the load on a potential target application node 112 to which a session could be moved to justify the movement of the session. While an idle application node 112 that was just started in order to take up some of the overall load should provide sufficient load difference to support a move decision, not every minor imbalance justifies the loss of cached data (if applicable), loss of database connections (if applicable), and the like when moving to another application node 112.

The goal is to optimize the response time of the system. The response time goes up as the load on the application node 112 increases. On the other hand, losing access to a session's data that resides in a cache also impacts the response time (e.g., right after the session move). For a given system, the impact on the response time of the loss of the data in the cache can be measured (for example, in milliseconds). The load vs. response time curve can also be determined (such as by measuring simulated loads on the system). FIG. 2B is an example load vs. response time diagram 260, according to an example embodiment. The response time axis 264 corresponds to the x-axis of the load vs. response time diagram 260 and the load axis 268 corresponds to the y-axis of the load vs. response time diagram 260. The response time of the load vs. response time curve 272 is relatively steady until the load reaches 70%; the response time then increases at greater loads. In the present example, a cache loss penalty line 276 represents the addition of the cache loss penalty of 100 ms to the response time for low loads (e.g., loads of less than 700/%). An example time to move a session is when the low load response time plus the cache loss penalty equals the response time of a higher load (e.g., a load greater than 70% i/). In the present example, the low load response time (500 ms) plus the cache loss penalty (100 ms) equals 600 ms; 600 ms corresponds to a load of 85% in the present example. Thus, an example time to move a session is when the load is 85%. Since the cache loss penalty is a one-time penalty, the session may be moved at an earlier time. For example, the session may be moved when the low load response time plus 50% of the cache loss penalty equals a higher load response time (e.g., a load greater than 70%). In the present example, the low load response time plus the 50% of the cache loss penalty equals 550 ms; 550 ms corresponds to a load of 80% in the present example. Thus, an example time to move a session is when the load is 80%. The two example loads (80% and 85%) may be used as a load range for determining when to move a session.

As the load on the overloaded application node 112 is reduced, the response times of the other sessions also improves. Note that the load may correlate to the number of active sessions; thus, as described above, the number of active sessions and the number of future sessions may be used in place of the load depicted in FIG. 2B as an indication of when to move a session. For example, if 800 sessions create an 80% load on the application node 112 and 250 sessions are inactive for 45 minutes (which results in a probability factor of 0.2 and thus an equivalent 50 active sessions), then the total session count is effectively 850 sessions for an 85% load.

With this concept, applications can maintain state for some period of time to complete multi-step processes. At the same time, the load balancer 108 is able to reassign requests to other application nodes 112 at the favorable times in between the multi-step processes. This increases the elasticity of load balancing as application nodes 112 that are started during high load situations get assigned sessions that are offloaded from those application nodes 112 that are under the most stress, as opposed to relying solely on session attrition. Rebalancing may occur within seconds instead of minutes or hours.

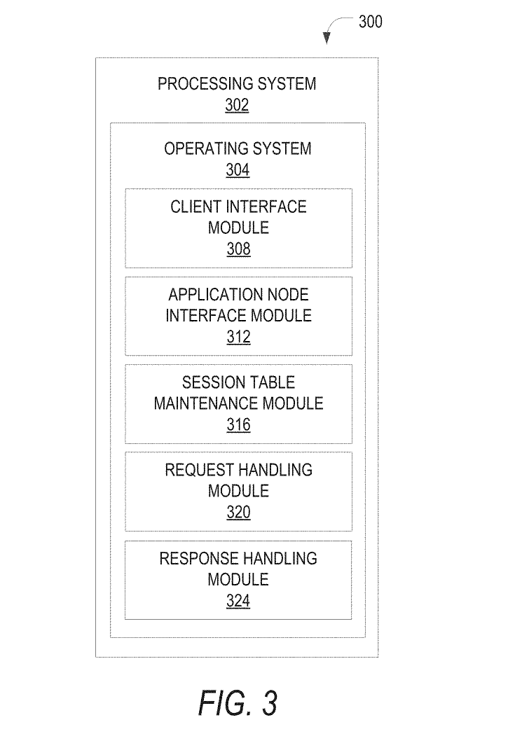

FIG. 3 is a block diagram of an example apparatus 300 for implementing a load balancer 108, in accordance with an example embodiment. The apparatus 300 is shown to include a processing system 302 that may be implemented on a client or other processing device, and that includes an operating system 304 for executing software instructions.

In accordance with an example embodiment, the apparatus 300 may include a client interface module 308, an application node interface module 312, a session table maintenance module 316, a request handling module 320, and a response handling module 324.

The client interface module 308 receives requests from and provides responses to the client devices 104. The application node interface module 312 provides requests to and receives responses from the application nodes 112.

The session table maintenance module 316 maintains information in the session table. The maintained information includes, for each node, the open session identifiers, a count of active requests for each session, a time of the last request, and an indication of whether the session is movable.

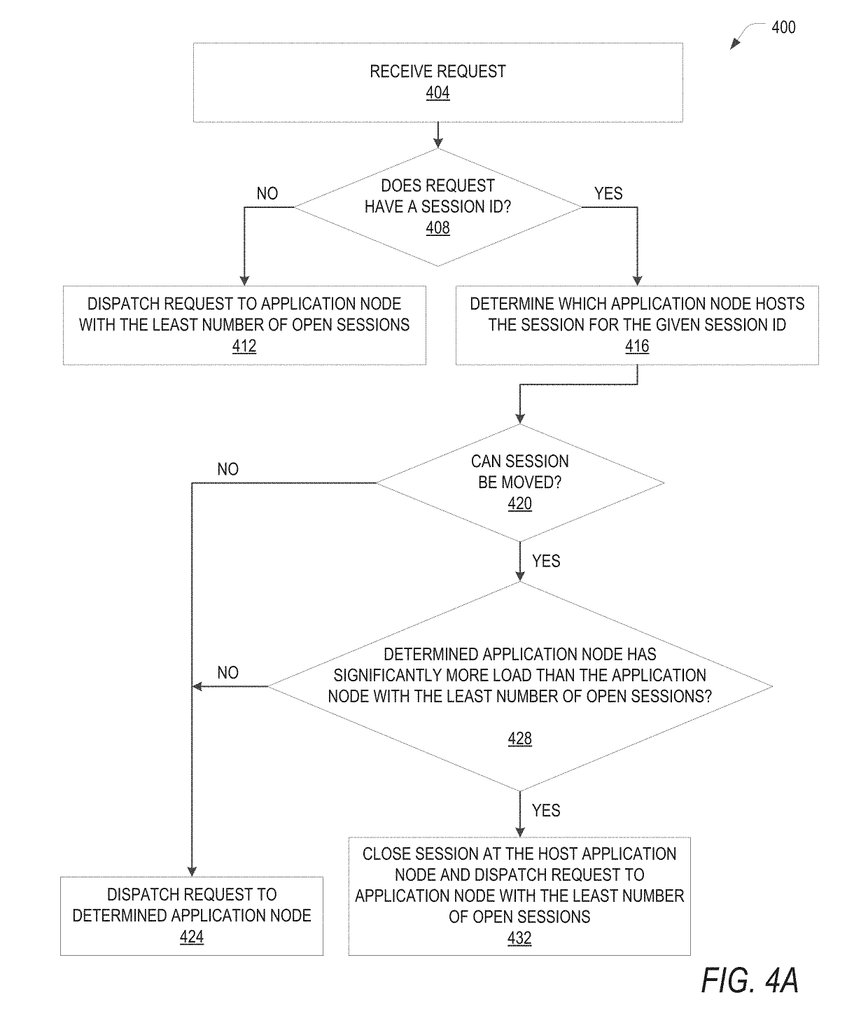

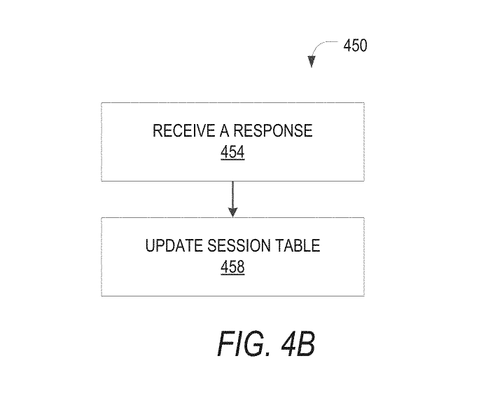

The request handling module 320 processes requests from the client devices 104, as described more fully by way of example in conjunction with FIG. 4A. The response handling module 324 processes responses from the application nodes 112, as described more fully by way of example in conjunction with FIG. 4B.

FIG. 4A is a flowchart for an example method 400 for processing an application request, according to an example embodiment. In one example embodiment, the method 400 is performed by the load balancer 108.

In one example embodiment, the load balancer 108 receives a request, such as a request from the client device 104 (operation 404). A determination is made of whether the request has a session identifier (operation 408). If the request has no session identifier, the request is dispatched to a selected application node 112, such as an application node 112 with the least number of open sessions (operation 412). In one example embodiment, the selected application node 112 may be based on the current load (given by the number of active requests for the current session as indicated in the session table), the future load that cannot be offloaded (given by the number of non-active, non-movable sessions, possibly adjusted by a probability factor based on how long ago the last request was received), or both, as described above. If the request has a session identifier, the application node 112 hosting the session corresponding to the session identifier is determined, such as by accessing the session table (operation 416).

A determination is made of whether the session corresponding to the request can be moved (operation 420). If the session cannot be moved at the current time (such as indicated by the session table), the request is dispatched to the application node 112 that hosts the session corresponding to the session identifier (operation 424).

If the session can be moved at the current time (such as indicated by the session table), a determination is made if the application node 112 that hosts the session corresponding to the session identifier has significantly more load than the application node 112 with the least number of open sessions (operation 428).

If the application node 112 that hosts the session corresponding to the session identifier does not have significantly more load than the application node 112 with the least number of open sessions, the request is dispatched to the application node 112 that hosts the session corresponding to the session identifier (operation 424). If the application node 112 that hosts the session corresponding to the session identifier has significantly more load than the application node 112 with the least number of open sessions, the session at the application node 112 that hosts the session corresponding to the session identifier is sent a session close command and the request is dispatched to the application node 112 with, for example, the least number of open sessions (operation 432). In one example embodiment, the load is based on the number of open sessions. In one example embodiment, the load is based on the current load (given by the number of active requests as indicated in the session table) and future load that cannot be offloaded (given by the number of non-active, non-movable sessions). In one example embodiment, the load is based on the current load (given by the number of active requests as indicated in the session table) and future load that cannot be offloaded (given by the number of non-active, non-movable sessions) adjusted by a probability factor based on how long ago the last request was received. The method 400 then ends.

FIG. 4B is a flowchart for an example method 450 for processing an application response, according to an example embodiment. In one example embodiment, the method 450 is performed by the load balancer 108.

In one example embodiment, the load balancer 108 receives a response, such as a request from the client device 104-1 (operation 454). The session table is updated, if necessary, according to the response (operation 458). For example, the active requests count is decremented. If the session was closed, the session is removed from the session table. If the session is identified as being movable, the corresponding session in the session table is marked accordingly. The method 450 then ends.

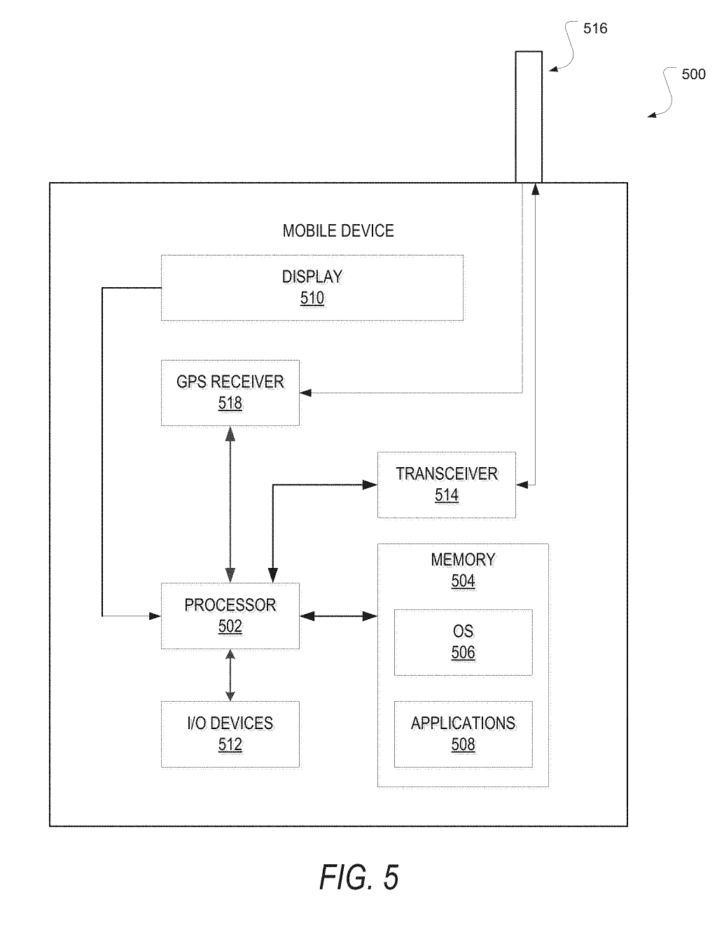

FIG. 5 is a block diagram illustrating a mobile device 500, according to an example embodiment. The mobile device 500 can include a processor 502. The processor 502 can be any of a variety of different types of commercially available processors suitable for mobile devices 500 (for example, an XScale architecture microprocessor, a microprocessor without interlocked pipeline stages (MIPS) architecture processor, or another type of processor). A memory 504, such as a random access memory (RAM), a Flash memory, or other type of memory, is typically accessible to the processor 502. The memory 504 can be adapted to store an operating system (OS) 506, as well as applications 508, such as a mobile location enabled application that can provide location-based services (LBSs) to a user. The processor 502 can be coupled, either directly or via appropriate intermediary hardware, to a display 510 and to one or more input/output (I/O) devices 512, such as a keypad, a touch panel sensor, and a microphone. Similarly, in some embodiments, the processor 502 can be coupled to a transceiver 514 that interfaces with an antenna 516. The transceiver 514 can be configured to both transmit and receive cellular network signals, wireless data signals, or other types of signals via the antenna 516, depending on the nature of the mobile device 500. Further, in some configurations, a global positioning system (GPS) receiver 518 can also make use of the antenna 516 to receive GPS signals.

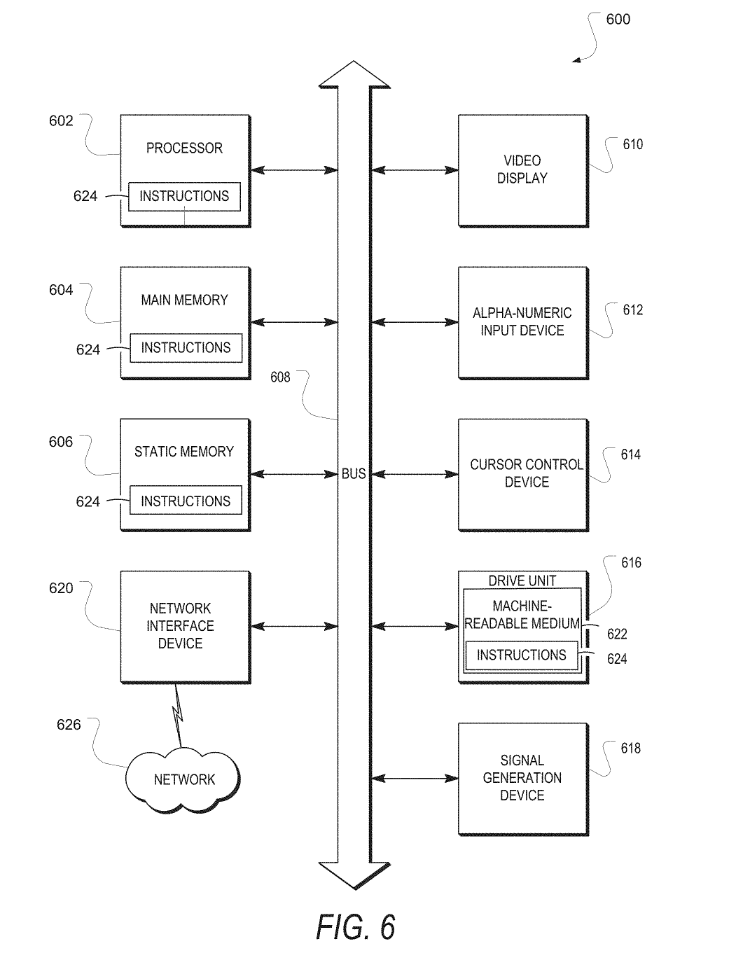

FIG. 6 is a block diagram of a computer processing system 600 within which a set of instructions 624 may be executed for causing a computer to perform any one or more of the methodologies discussed herein. In some embodiments, the computer operates as a standalone device or may be connected (e.g., networked) to other computers. In a networked deployment, the computer may operate in the capacity of a server or a client computer in server-client network environment, or as a peer computer in a peer-to-peer (or distributed) network environment.

In addition to being sold or licensed via traditional channels, embodiments may also, for example, be deployed by software-as-a-service (SaaS), application service provider (ASP), or by utility computing providers. The computer may be a server computer, a personal computer (PC), a tablet PC, a personal digital assistant (PDA), a cellular telephone, or any processing device capable of executing a set of instructions 624 (sequential or otherwise) that specify actions to be taken by that device. Further, while only a single computer is illustrated, the term “computer” shall also be taken to include any collection of computers that, individually or jointly, execute a set (or multiple sets) of instructions 624 to perform any one or more of the methodologies discussed herein.

The example computer processing system 600 includes a processor 602 (e.g., a central processing unit (CPU), a graphics processing unit (GPU), or both), a main memory 604, and a static memory 606, which communicate with each other via a bus 608. The computer processing system 600 may further include a video display 610 (e.g., a plasma display, a liquid crystal display (LCD), or a cathode ray tube (CRT)). The computer processing system 600 also includes an alphanumeric input device 612 (e.g., a keyboard), a user interface (UI) navigation device 614 (e.g., a mouse and/or touch screen), a drive unit 616, a signal generation device 618 (e.g., a speaker), and a network interface device 620.

The drive unit 616 includes a machine-readable medium 622 on which is stored one or more sets of instructions 624 and data structures embodying or utilized by any one or more of the methodologies or functions described herein. The instructions 624 may also reside, completely or at least partially, within the main memory 604, the static memory 606, and/or within the processor 602 during execution thereof by the computer processing system 600, the main memory 604, the static memory 606, and the processor 602 also constituting tangible machine-readable media 622.

The instructions 624 may further be transmitted or received over a network 626 via the network interface device 620 utilizing any one of a number of well-known transfer protocols (e.g., Hypertext Transfer Protocol).

While the machine-readable medium 622 is shown, in an example embodiment, to be a single medium, the term “machine-readable medium” should be taken to include a single medium or multiple media (e.g., a centralized or distributed database, and/or associated caches and servers) that store the one or more sets of instructions 624. The term “machine-readable medium” shall also be taken to include any medium that is capable of storing, encoding, or carrying a set of instructions 624 for execution by the computer and that cause the computer to perform any one or more of the methodologies of the present application, or that is capable of storing, encoding, or carrying data structures utilized by or associated with such a set of instructions 624. The term “machine-readable medium” shall accordingly be taken to include, but not be limited to, solid-state memories and optical and magnetic media.

While the embodiments of the invention(s) is (are) described with reference to various implementations and exploitations, it will be understood that these embodiments are illustrative and that the scope of the invention(s) is not limited to them. In general, techniques for maintaining consistency between data structures may be implemented with facilities consistent with any hardware system or hardware systems defined herein. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the invention(s).

What is claimed is:

1. A computerized method for processor node load balancing comprising:
receiving, from a client hardware device, a request for processing, the request having a session identifier;
determining, using one or more hardware processors, a movable status of a session corresponding to the request, the session executing on a first hardware processor node of a plurality of hardware processor nodes;
determining, using the one or more hardware processors, a load status of the first hardware processor node corresponding to the session; and
forwarding the request to a selected hardware processor node selected from the plurality of hardware processor nodes based on the movable status and the load status.

2. The computerized method of claim 1, wherein the movable status is non-movable and the first hardware processor node is assigned to be the selected hardware processor node.

3. The computerized method of claim 1, wherein the movable status is movable and the first hardware processor node is assigned to be the selected hardware processor node.

4. The computerized method of claim 1, wherein the movable status is movable and another hardware processor node of the plurality of hardware processor nodes is assigned to be the selected hardware processor node based on the load status.

5. The computerized method of claim 4, wherein the another hardware processor node has a lighter load than the first hardware processor node.

6. The computerized method of claim 5, wherein the load is based on a count of open requests and a non-active, non-movable parameter, the non-active, non-movable parameter based on a count of non-active, non-movable sessions.

7. The computerized method of claim 6, wherein the non-active, non-movable parameter is based on the count of non-active, non-movable sessions adjusted by a probability factor, the probability factor based on an amount of time since a last request was received.

8. The computerized method of claim 4, further comprising issuing a close session request to the first hardware processor node and dispatching the request to the another hardware processor node.

9. The computerized method of claim 4, further comprising receiving a response from the another hardware processor node, the response comprising a new session identifier.

10. The computerized method of claim 1, further comprising:
receiving a second request from the client hardware device, the request lacking a session identifier, and
dispatching the second request to a hardware processor node having a least number of open sessions.

11. The computerized method of claim 1, further comprising tracking a movable status of the session corresponding to the request.

12. The computerized method of claim 1, further comprising tracking a count of open requests and a time of a last request of the session corresponding to the request.

13. The computerized method of claim 11, wherein the movable status is updated in response to receiving a response from the first hardware processor node.

14. An apparatus for processor node load balancing, the apparatus comprising:
one or more processors;
memory to store instructions that, when executed by the one or more hardware processors perform operations comprising:
receiving, from a client hardware device, a request for processing, the request having a session identifier;
determining, using one or more hardware processors, a movable status of a session corresponding to the request, the session executing on a first hardware processor node of a plurality of hardware processor nodes;
determining, using the one or more hardware processors, a load status of the first hardware processor node corresponding to the session; and
forwarding the request to a selected hardware processor node selected from the plurality of hardware processor nodes based on the movable status and the load status.

15. The apparatus of claim 14, wherein the movable status is non-movable and the first hardware processor node is assigned to be the selected hardware processor node.

16. The apparatus of claim 14, wherein the movable status is movable and the first hardware processor node is assigned to be the selected hardware processor node.

17. The apparatus of claim 14, wherein the movable status is movable and another hardware processor node of the plurality of hardware processor nodes is assigned to be the selected hardware processor node based on the load status.

18. The apparatus of claim 14, wherein the load is based on a count of open requests and a non-active, non-movable parameter, the non-active, non-movable parameter based on a count of non-active, non-movable sessions.

19. The apparatus of claim 14, further comprising:
receiving a second request from the client hardware device, the request lacking a session identifier; and
dispatching the second request to a hardware processor node having a least number of open sessions.

20. A non-transitory machine-readable storage medium comprising instructions, which when implemented by one or more machines, cause the one or more machines to perform operations comprising:
receiving, from a client hardware device, a request for processing, the request having a session identifier;
determining, using one or more hardware processors, a movable status of a session corresponding to the request, the session executing on a first hardware processor node of a plurality of hardware processor nodes;
determining, using the one or more hardware processors, a load status of the first hardware processor node corresponding to the session; and
forwarding the request to a selected hardware processor node selected from the plurality of hardware processor nodes based on the movable status and the load status.
